(19) United States
(12) Patent Application Publication
(10) Pub. No.: US 2018/0347991 A1
(43) Pub. Date: Dec. 6, 2018

(54) METHOD, DEVICE, MAP MANAGEMENT APPARATUS, AND SYSTEM FOR PRECISION-LOCATING A MOTOR VEHICLE IN AN ENVIRONMENT

(71) Applicant: VOLKSWAGEN AKTIENGESELLSCHAFT, Wolfsburg (DE)

(72) Inventors: Andreas TITZE, Braunschweig (DE); Stefan ORTMANN, Braunschweig (DE)

(21) Appl. No.: 15/778,237

(22) PCT Filed: Nov. 9, 2016
(86) PCT No.: PCT/EP2016/077112

§ 371 Date: May 23, 2018

(30) Foreign Application Priority Data
Nov. 25, 2015 (DE) 10 2015 015 156.8
Apr. 1, 2016 (DE) 10 2016 205 433.3

(51) Int. Cl. G01C 21/30; G06K 9/00; G06T 7/73; G06K 9/62

(52) U.S. Cl. CPC G01C 21/30; G06K 9/00791; G06T 7/74; G06T 2207/30261; G06K 9/628; G06K 9/00798; G06K 9/00805

(57) ABSTRACT

A system for precision-locating a motorized transportation vehicle in an environment including a device for capturing a sequence of images of the environment of the motorized transportation vehicle by at least one camera; detecting and classifying objects in the captured sequence of images by an evaluating unit; determining object positions of the objects relative to the motorized transportation vehicle by the evaluating unit; defining a section in the environment; allocating the objects to the determined object positions in the specified section; identifying a lane of the motorized transportation vehicle in the section; transmitting object information and the positions of the objects, section information on the defined section, lane information and time information to a map management apparatus by a transmitting apparatus. Also disclosed is a device, an associated map management apparatus, and to an associated system.

### PRIORITY CLAIM

This patent application is a U.S. National Phase of International Patent Application No. PCT/EP2016/077112, filed 9 Nov. 2016, which claims priority to German Patent Application Nos. 10 2015 015 156.8, filed 25 Nov. 2015, and 10 2016 205 433.3, filed 1 Apr. 2016, the disclosures of which are incorporated herein by reference in their entireties.

### SUMMARY

Illustrative embodiments relate to an apparatus for a motorized transportation vehicle, to a map management device, to a system and to a method for precisely locating the motorized transportation vehicle in an environment.

### BRIEF DESCRIPTION OF THE DRAWINGS

The disclosed embodiments are explained in more detail below with reference to the figures, in which:

FIG. 1 shows a schematic illustration of an embodiment of the system for precisely locating a motorized transportation vehicle in an environment;

FIG. 2 shows a schematic illustration of a typical environment of a motorized transportation vehicle for illustrating the method; and

FIG. 3 shows a schematic illustration of a defined section having lane functions.

### DETAILED DESCRIPTION

Modern motorized transportation vehicles have a multiplicity of assistance systems, including navigation systems which are able to locate a motorized transportation vehicle within an environment. Such a navigation system is based, for example, on a global positioning system (GPS) in which a position of the motorized transportation vehicle is determined by evaluating a plurality of satellite-based signals. Furthermore, systems in which maps are created from the environment of the motorized transportation vehicle are also known. In the case of a subsequent journey through a region which has already been mapped, the motorized transportation vehicle can then be located in the created map.

DE 10 2014 002 821 A1 discloses a method for locating a mobile device in a surrounding area, the device having a plurality of sensors for capturing the surrounding area of the device using different locating methods, a reference map which comprises a plurality of positions within the surrounding area being available for the surrounding area, at least one locating method which can be carried out using at least one sensor for capturing the surrounding area being recommended for at least one position within the surrounding area, the at least one locating method which can be carried out using at least one sensor and is recommended according to the reference map being used to locate the device for a current position of the mobile device.

DE 10 2011 119 762 A1 discloses a positioning system suitable for a motorized transportation vehicle and a corresponding method. The system comprises a digital map in which data relating to location-specific features are recorded in a localized manner, at least one environment detection apparatus for capturing the location-specific features in the surrounding area of the transportation vehicle, and a locating module coupled to the digital map and the environment detection apparatus. The locating module has a processing unit for comparing the captured data and the data recorded in the digital map using the location-specific features and for locating the transportation vehicle position on the basis of the location-specific features recorded in a localized manner in the digital map. The system also comprises an inertial measuring unit of the transportation vehicle for transportation vehicle movement data, which measuring unit is coupled to the locating module, the processing unit of which is configured to determine the transportation vehicle position by the transportation vehicle movement data on the basis of the position located on the basis of the location-specific features.

Disclosed embodiments provide a method and a system for locating a motorized transportation vehicle in an environment, in which the process of locating the motorized transportation vehicle in the environment is improved.

Disclosed embodiments provide a method, an apparatus, a map management device, and a system.

A method for precisely locating a motorized transportation vehicle in an environment is provided, comprising the following operations in an apparatus in the motorized transportation vehicle: capturing an image sequence of the environment of the motorized transportation vehicle by at least one camera, identifying and classifying objects in the captured image sequence by an evaluation unit, determining object positions of the objects relative to the motorized transportation vehicle by the evaluation unit, defining a section in the environment, the section having a predetermined size and predetermined boundaries, assigning the identified and classified objects to the determined object positions in the defined section, determining a lane of the motorized transportation vehicle in the section by the evaluation unit, transmitting object information and the object positions of the identified and classified objects, section information relating to the defined section, lane information and an item of time information to a map management device by a transmitting device; and comprising the following operations in the map management device: receiving the object information and the object positions, the section information, the lane information and the time information for the section from the apparatus, comparing the received information relating to the section with a digital map on the basis of the object information and object positions, the section information, the lane information and the time information, determining a corresponding section in the digital map, transmitting environmental data corresponding to the section from the digital map to the apparatus; also comprising the following operations in the apparatus in the motorized transportation vehicle: receiving the environmental data from the map management device by a receiving device, comparing the received environmental data with the defined section by the evaluation unit, locating the motorized transportation vehicle in the environment on the basis of the comparison result by the evaluation unit.

An apparatus for a motorized transportation vehicle for precisely locating the motorized transportation vehicle in an environment is also provided, comprising at least one camera for capturing an image sequence of the environment of the motorized transportation vehicle, an evaluation unit, wherein the evaluation unit is designed to identify and classify objects in the captured image sequence, to determine object positions of the identified and classified objects relative to the camera, to define a section in the environment, the section having a predetermined size and predetermined boundaries, to assign the identified and classified objects to the determined object positions in the defined section, and to determine a lane of the motorized transportation vehicle in the section, and a transmitting device which is designed to transmit object information and the object positions of the identified and classified objects, section information relating to the defined section, lane information and an item of time information to a map management device, and a receiving device which is designed to receive the environmental data from the map management device, the evaluation unit also being designed to compare the received environmental data with the defined section and to locate the motorized transportation vehicle in the environment on the basis of the comparison result.

A map management device is also provided, comprising a receiving device which is designed to receive the object information and the object positions, the section information, the lane information and the time information for the section from the apparatus, a comparison device which is designed to compare the received information relating to the section with a digital map on the basis of the object information and object positions, the section information, the lane information and the time information and to determine a corresponding section in the digital map, and a transmitting device which is designed to transmit environmental data corresponding to the section from the digital map to the motorized transportation vehicle.

In combination, this forms a system for precisely locating a motorized transportation vehicle in an environment, comprising at least one apparatus for a motorized transportation vehicle for precisely locating the motorized transportation vehicle in an environment and a map management device.

At least one disclosed embodiment provides for the determined lane in a section to be described by a corridor comprising a left-hand lane boundary and a right-hand lane boundary, the left-hand lane boundary and the right-hand lane boundary each being described as lane functions. Consequently, a volume of data needed to describe the lane can be reduced. This saves bandwidth during communication between the at least one mobile device and the map management device via a communication connection.

At least one disclosed embodiment provides for the lane functions to be third-degree polynomial functions. This results in great data reduction with simultaneous flexibility. Only four coefficients must then be transmitted for each coordinate, with the result that a total of twelve coefficients for each section must be transmitted in the case of three dimensions. In this case, provision may be made, in particular, for the polynomial functions to have a time as an independent variable. However, it is likewise possible to use a location coordinate, for example, a road etc., as an independent variable.

Another disclosed embodiment provides for the motorized transportation vehicle to be located in the defined section by comparing the left-hand lane boundary and the right-hand lane boundary and/or the associated lane functions with the environmental data received for this defined section. Consequently, a locating process can be carried out in a particularly efficient and rapid manner since only very few items of data have to be compared with one another.

At least one disclosed embodiment provides, in particular, for one or more items of position information corresponding to the defined section to be additionally determined in the motorized transportation vehicle by a global positioning device, this position information likewise being transmitted to the map management device and being taken into account by the map management device during comparison. Consequently, the comparison process is accelerated since a rough position of the motorized transportation vehicle in the environment or in the digital map is already known. As a result, only a smaller region in the digital map has to be compared with the transmitted data and investigated for similarity. The Global Positioning System (GPS) or the Galileo system, for example, can be used as the global positioning system.

Another disclosed embodiment provides for object positions for objects in the environment of the motorized transportation vehicle relative to the latter to be determined from the received environmental data. This makes it possible to provide an accurate relative position of the objects with respect to the motorized transportation vehicle. This is beneficial if the motorized transportation vehicle is driven in a semi-automatic or automatic manner. An exact orientation and position in the environment can then be determined for the motorized transportation vehicle on the basis of the objects.

Another disclosed embodiment also provides for the map management device to classify objects contained in the environmental data either as landmarks or as obstacles. Such a classification subsequently makes it possible for the evaluation unit in the motorized transportation vehicle to quickly and efficiently identify obstacles and to circumvent them or stop in front of them in good time. In addition, a classification in the map management device makes it possible to save computing power since, in the case of a plurality of apparatuses or motorized transportation vehicles, a classification must be carried out only once and not every apparatus or every motorized transportation vehicle has to individually classify the objects. Overall, resources are saved in this manner and the costs can be reduced.

Provision may also be made for the digital map to also be created by the map management device. For this purpose, the map management device evaluates the object information and the object positions of the identified and classified objects, section information relating to the defined section, lane information and an item of time information transmitted from the apparatus in the motorized transportation vehicle and/or apparatuses in other motorized transportation vehicles or other mobile devices and joins adjacent sections. The joined sections are then merged to form the digital map.

Parts of the apparatus, of the map management device and also of the system may, individually or in combination, be a combination of hardware and software, for example, program code which is executed on a microcontroller or microprocessor.

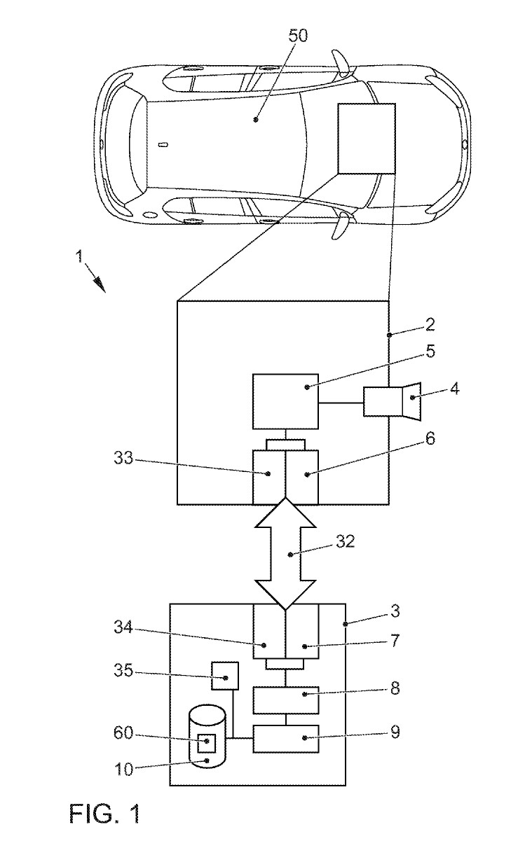

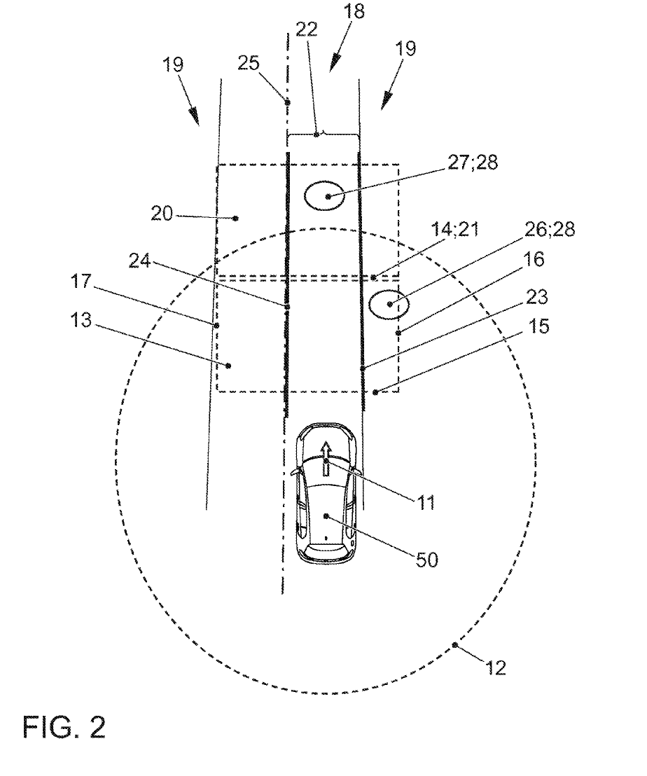

FIG. 1 illustrates a schematic illustration of a system 1 for precisely locating a motorized transportation vehicle 50 in an environment 12 (see FIG. 2). The system 1 comprises at least one apparatus 2 which is formed in the motorized transportation vehicle 50 in this example, and a map management device 3 which may be a central server, for example. The map management device is also intended to create a digital map below.

The apparatus 2 comprises a camera 4, an evaluation unit 5, a transmitting device 6, and a receiving device 33. The map management device 3 comprises, for example, a receiving device 7, a joining device 8, a merging device 9, a memory 10 which stores a digital map 60, a transmitting device 34 and a comparison device 35.

FIG. 2 shows a schematic illustration of a typical environment 12 of a motorized transportation vehicle 50 for illustrating the method. The camera 4 (see FIG. 1) points in a direction of travel 11 of the motorized transportation vehicle 50, for example. The camera 4 captures a sequence of images of the environment 12 of the motorized transportation vehicle 50. The captured sequence of images is passed from the camera 4 to the evaluation unit 5. The evaluation unit 5 defines a section 13 from the sequence of images. This section 13 has a predefined size. Such a section 13 also has a front boundary 14, a rear boundary 15, a right-hand boundary 16 and a left-hand boundary 17. The defined section 13 contains a portion of a road 18 on which the motorized transportation vehicle 50 is currently situated and a part of the surrounding area 19 of the road 18. A further section 20 is defined at a later time from a further sequence of images, with the result that the rear boundary 21 of the further section 20 is the same as the front boundary 14 of the section 13 defined before it. In this manner, the environment 12 of the motorized transportation vehicle 50 is gradually captured at different times and is gradually concatenated as sections 13, 20.

In each section 13, 20, the evaluation unit 5 determines a lane 22 of the motorized transportation vehicle 50. In this example, the lane 22 is bounded on the right-hand side by the roadway boundary 23 of the road 18, in which case the right-hand roadway boundary 23 can be given by the right-hand roadway line, for example. The left-hand lane boundary 24 of the lane 22 is given by a center line 25 of the road 18, for example.

The respective lane boundary 23, 24 of the lane 22 is recognized by an image recognition method in the evaluation unit 5 and is mathematically represented as a third-degree polynomial function for each coordinate, for example:

X(t)=a₃t³+a₂t²+a₁t+a₀,

Y(t)=b₃t³+b₂t²+b₁t+b₀,

Z(t)=c₃t³+c₂t²+c₁t+c₀.

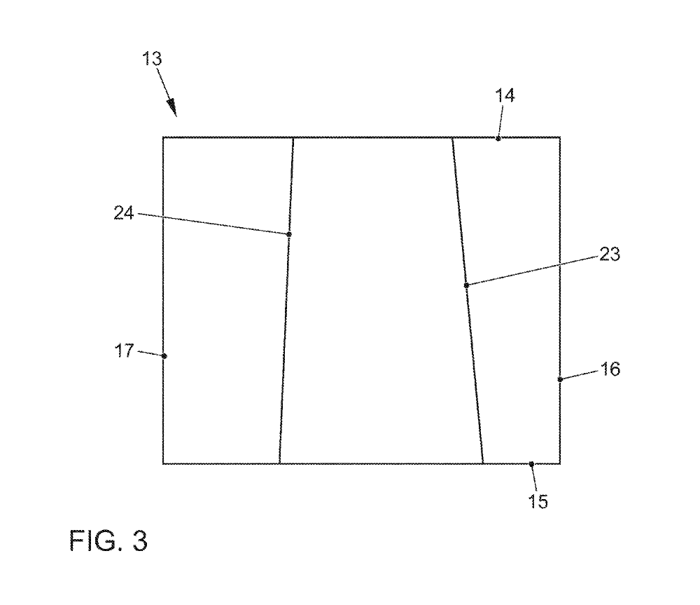

The coordinates X, Y and Z relate to a coordinate system which is based, for example, on the camera position or the center point of the front boundary 14 of the section 22. The coordinate X describes the coordinate system in the direction of travel 11, the coordinate Y describes the coordinate system in the lateral direction and the coordinate Z describes the coordinate system in the vertical direction. The function X(t) therefore describes a function in the X direction on the basis of a time t which is related to the time at which the section 13 was determined. Each point of the detected lane 22 is therefore spatially defined. The coefficients of the lane functions can be mathematically determined by suitable fitting methods, with the result that the individual lane functions are defined by the determined coefficients a1, a2, a3, a0 and b1, b2, b3, b0 and c1, c2, c3, c0 and map the lane boundaries 23, 24 as a function of the time. FIG. 3 shows a schematic illustration of the section 13 having the lane functions.

The coefficients form an item of lane information which is transmitted, together with an item of time information and an item of section information, to the map management device 3 or the server by the transmitting device 6 of the apparatus 2. Transmission is carried out using a wireless communication connection 32, for example, see FIG. 1. The practice of describing the lane 22 by the polynomial functions makes it possible to considerably reduce the volume of data to be transmitted, with the result that only small volumes of data have to be transmitted for each section 13, 20.

Furthermore, provision is also made for further objects 28 in the environment 12 to be captured. There are, for example, a landmark 26 and an obstacle 27 in the surrounding area 19 of the lane 22 and in the lane 22. The landmark 26 may be, for example, a tree or road lighting. The obstacle 27 may be, for example, a further motorized transportation vehicle which marks the end of a traffic jam, or an indication that work is being carried out on this lane 22 and it is necessary to change the lane 22.

The camera 4 captures image contents, and a suitable object recognition method can be used to determine what object 28 is involved. All known object recognition methods, in particular, pattern recognition methods, can be used in this case. It is likewise possible to determine a position of the object 28, for example, relative to the camera 4. This is carried out, for example, by comparing the identified objects 28 with objects stored in tables. As a result, a size of the objects 28 is determined and a distance to the motorized transportation vehicle 50 or to the camera 4 can then be inferred. The position of the object 28 is known by determining the angles of the objects 28 relative to the camera 4 in a plurality of sections 13, 20 determined in succession. The position can be defined, for example, as a vector or as a coordinate with a corresponding object type. This object information is likewise determined as a function of the time for each section 13, 20 and is transmitted to the map management device 3 or the server by the transmitting device 6.

The map management device 3 receives object information and associated object positions, section information, lane information and time information for each of the sections 13, 20. These are then combined by a suitable method such that a digital map 60 having the lane 22 is produced. Known pattern recognition methods, for example, can be used in this case to combine the sections. With the available information, such a method is able to assign the section information and to join the sections 13, 20 to one another given appropriate correspondence.

The individual sections 13, 20 are joined in the map management device 3, for example, by a joining device 8.

The similarity between various sections 13, 20 is determined, for example, by comparing the coefficients of the lane functions. If these correspond, it can be assumed that the same lane 22 is involved. For the purpose of verification, yet further information is compared, for example, the object information relating to the type and position of objects 28 which are situated outside the lane 22.

The digital map 60 of the lane 22 can be improved by virtue of the fact that a multiplicity of apparatuses 2, for example, in a multiplicity of motorized transportation vehicles 50, each transmit object information and associated object positions, section information, lane information and time information for each of the sections to the map management device 3 and the map management device 3 uses this information to create the digital map 60 with a high degree of accuracy, for example, by weighting and averaging or superimposition.

A plurality of sections 13, 20 of a plurality of apparatuses 2 are averaged in the map management device 3, for example, by the merging device 9. The digital map 60 is stored in the memory 10 and can be changed there at any time and retrieved again.

If, for example, an object 28 in a section 13, 20 has changed, the method in the map management device 3 ensures that a particular number of items of information correspond in a first operation. These may be, for example, the coefficients of the lanes 22. If further parameters also correspond in a comparison, for example, object sizes and object types of the objects 28 (for example, in the case of a tree), it is assumed that this is a section 13, 20 which has already been captured at an earlier time and has been stored in the digital map 60.

An image of the environment 12 in a local (digital map 60) and global coordinate system is therefore compiled in the map management device 3 or in the server and comprises a multiplicity of items of information from sections 13, 20. A multiplicity of captured sequences of images from a plurality of apparatuses 2 can therefore be merged to form a single, highly accurate digital map 60.

A highly accurate location in a world coordinate system can be calculated by identifying and classifying objects as landmarks 26 or as an obstacle 27 and averaging the associated object positions. This is used to anchor the sections 13, 20 in the digital map 60.

The map management device is able to transmit the compiled image of the environment 12 to the apparatus 2 in the motorized transportation vehicle 50 again as a digital map 60. For this purpose, the received object information and object positions, section information, lane information and the time information for the section 13 are evaluated by a comparison device 35 of the map management device 3 by comparing the section 13 with the digital map 60. The environmental data corresponding to the section 13 from the digital map 60 are then transmitted to the apparatus 2 by a transmitter device 34.

If the apparatus 2 receives the environmental data by the receiving device 33, the received section of the environment 12 is compared with the section 13 which has just been recorded in the evaluation unit 5 and the exact position of the apparatus 2 in the motorized transportation vehicle 50 is determined by evaluating the difference. This method makes it possible to determine the exact position of the motorized transportation vehicle 50 in the lane 22. It is additionally possible to determine the exact position of objects 28 in the environment 12 of the motorized transportation vehicle 50.

This makes it possible to accurately determine the left-hand boundary 24 and the right-hand boundary 23 of the lane 22 in the centimeter range. As a result, the motorized transportation vehicle 50 is able to accurately locate itself in the lane 22. This accurate localization is important for automated journeys.

It is likewise beneficial to accurately locate objects 28 in the environment 12 of the motorized transportation vehicle 50 and to note them in the digital map 60. In this case, it is beneficial if an object 28 has been classified as an obstacle 27 in the lane 22 in the map management device 3. The motorized transportation vehicle 50 is able to circumvent precisely this obstacle 27, to stop in front of this obstacle 27 or to warn other road users of this obstacle by virtue of the corresponding classification of the obstacle 27 being transmitted to the apparatus 2 in the motorized transportation vehicle 50.

Provision may also be additionally made for a rough position estimate to be made using an additional global positioning system (GPS) in the motorized transportation vehicle 50. The position estimate is then likewise transmitted to the map management device 3, with the result that the corresponding section 13, 20 can be found more efficiently and more quickly in the digital map 60.

Parts of the apparatus 2, of the map management device 3 and also of the system 1 may be, individually or in combination, a combination of hardware and software, for example, as program code which is executed on a microcontroller or microprocessor.

### LIST OF REFERENCE SYMBOLS

1 System
2 Apparatus
3 Map management device
4 Camera
5 Evaluation unit
6 Transmitting device
7 Receiving device
8 Joining device
9 Merging device
10 Memory
11 Direction of travel
12 Environment
13 Section
14 Front boundary
15 Rear boundary
16 Right-hand boundary
17 Left-hand boundary
18 Road
19 Surrounding area
20 Further section
21 Rear boundary of the further section
22 Lane
23 Right-hand roadway boundary
24 Left-hand lane boundary
25 Center line
26 Landmark
27 Obstacle
28 Object
32 Communication connection
33 Receiving device
34 Transmitting device
35 Comparison device
50 Motorized transportation vehicle
60 Digital map

1. A method for precisely locating a transportation vehicle in an environment, the method comprising:
in an apparatus in the transportation vehicle:
capturing an image sequence of the environment of the motorized transportation vehicle by at least one camera,
identifying and classifying objects in the captured image sequence by an evaluation unit,
determining object positions of the objects relative to the motorized transportation vehicle by the evaluation unit,
defining a section in the environment, the section having a predetermined size and predetermined boundaries,
assigning the identified and classified objects to the determined object positions in the defined section,
determining a lane of the motorized transportation vehicle in the section by the evaluation unit, and
transmitting object information and the object positions of the identified and classified objects, section information relating to the defined section, lane information and an item of time information to a map management device by a transmitting device;
in the map management device:
receiving the object information and the object positions, the section information, the lane information and the time information for the section from the apparatus,
comparing the received information relating to the section with a digital map based on the object information and object positions, the section information, the lane information and the time information,
determining a corresponding section in the digital map, and
transmitting environmental data corresponding to the section from the digital map to the apparatus; and
in the apparatus in the transportation vehicle:
receiving the environmental data from the map management device by a receiving device,
comparing the received environmental data with the defined section by the evaluation unit, and
locating the transportation vehicle in the environment based on the comparison result by the evaluation unit.

2. The method of claim 1, wherein the determined lane in a section is described by a corridor comprising a left-hand lane boundary and a right-hand lane boundary, the left-hand lane boundary and the right-hand lane boundary each being described as lane functions.

3. The method of claim 2, wherein the lane functions are third-degree polynomial functions.

4. The method of claim 1, wherein the transportation vehicle is located in the defined section by comparing the left-hand lane boundary and the right-hand lane boundary and/or the associated lane functions with the environmental data received for this defined section.

5. The method of claim 1, wherein one or more items of position information corresponding to the defined section are additionally determined in the transportation vehicle by a global positioning device, this position information likewise being transmitted to the map management device and being taken into account by the map management device during comparison.

6. The method of claim 1, wherein object positions for objects in the environment of the transportation vehicle relative to the transportation vehicle are determined from the received environmental data.

7. The method of claim 1, wherein the map management device classifies objects contained in the environmental data either as landmarks or as obstacles.

8. An apparatus for a transportation vehicle for precisely locating the transportation vehicle in an environment, they apparatus comprising:
at least one camera for capturing an image sequence of the environment of the transportation vehicle;
an evaluation unit, wherein the evaluation unit identified and classified objects in the captured image sequence, determines object positions of the identified and classified objects relative to the camera, defines a section in the environment, the section having a predetermined size and predetermined boundaries, assigns the identified and classified objects to the determined object positions in the defined section, and determines a lane of the transportation vehicle in the section, and
a transmitting device to transmit object information and the object positions of the identified and classified objects, section information relating to the defined section, lane information and an item of time information to a map management device, and
a receiving device to receive the environmental data from the map management device,
the evaluation unit also compares the received environmental data with the defined section and locates the transportation vehicle in the environment based on the comparison result.

9. A map management device; comprising:
a receiving device to receive the object information and the object positions, the section information, the lane information and the time information for the section from the apparatus;
a comparison device to compare the received information relating to the section with a digital map based on the object information and object positions, the section information, the lane information and the time information and to determine a corresponding section in the digital map; and
a transmitting device to transmit environmental data corresponding to the section from the digital map to the transportation vehicle.

10. A system for precisely locating a transportation vehicle in an environment, the system comprising at least one apparatus as claimed in claim 8 and a map management device including a receiving device to receive the object information and the object positions, the section information, the lane information and the time information for the section from the apparatus, a comparison device to compare the received information relating to the section with a digital map based on the object information and object positions, the section information, the lane information and the time information and to determine a corresponding section in the digital map, and a transmitting device to transmit environmental data corresponding to the section from the digital map to the transportation vehicle.

11. The system of claim 10, wherein the determined lane in a section is described by a corridor comprising a left-hand lane boundary and a right-hand lane boundary, the left-hand lane boundary and the right-hand lane boundary each being described as lane functions.

12. The system of claim 11, wherein the lane functions are third-degree polynomial functions.

13. The system of claim 10, wherein the transportation vehicle is located in the defined section by comparing the left-hand lane boundary and the right-hand lane boundary and/or the associated lane functions with the environmental data received for this defined section.

14. The system of claim 10, wherein one or more items of position information corresponding to the defined section are additionally determined in the transportation vehicle by a global positioning device, this position information likewise being transmitted to the map management device and being taken into account by the map management device during comparison.

15. The system of claim 10, wherein object positions for objects in the environment of the transportation vehicle relative to the transportation vehicle are determined from the received environmental data.

16. The system of claim 10, wherein the map management device classifies objects contained in the environmental data either as landmarks or as obstacles.
